(19) United States
(12) Patent Application Publication
(10) Pub. No.: US 2026/0045155 A1
(43) Pub. Date: Feb. 12, 2026

(54) SYSTEM AND METHOD FOR MEASURING AND SHARING MARINE ACTIVITY INFORMATION

(71) Applicant: Fishing Chaos, Inc, Mobile, AL (US)

(72) Inventor: John Calagaz, Mobile, AL (US)

(73) Assignee: Fishing Chaos, Inc, Mobile, AL (US)

(21) Appl. No.: 18/800,884

(22) Filed: Aug. 12, 2024

Related U.S. Application Data
(63) Continuation-in-part of application No. 17/050,692, now Pat. No. 12,084,150.
(60) Provisional application No. 62/532,994, filed on Jul. 15, 2017.

(51) Int. Cl. G08B 21/18; G01C 5/06; G01H 17/00; G01J 1/42; G01W 1/06

(52) U.S. Cl. CPC G08B 21/18; G01C 5/06; G01H 17/00; G01J 1/4204; G01W 1/06

(57) ABSTRACT

A system and method for managing information related to marine activities and selectively sharing such information is provided. The system is designed to collect environmental data and create buoy profiles that may be analyzed by users to scout environmental conditions that may be conducive to catching fish in certain geolocations. Buoy profiles are updated in real time by fisherman using the system. The system is also designed to collect information pertaining to a catch and create an activity profile that may be analyzed by users to scout optimal geolocations in which to catch fish. A user's activity profiles may be shared with other users or kept private depending on permission levels within the system. Additionally, the system is designed to alert users of dangerous weather conditions and optimal fishing geolocations based on the buoy profiles and environmental states created by the system.

### CROSS REFERENCES

This application is a continuation of a co-pending U.S. patent application Ser. No. 17/050,692, filed Oct. 26, 2020, which claims priority to International Patent Application Serial No. PCT/US18/42201, filed on Jul. 15, 2018, which claims priority to U.S. Provisional Application Ser. No. 62/532,994, filed on Jul. 15, 2017, in which all said applications are incorporated herein in their entirety by reference.

### FIELD OF THE DISCLOSURE

The subject matter of the present disclosure refers generally to a system and method for measuring and sharing data related to marine activities.

### BACKGROUND

The ability to use data involving environmental conditions to predict future weather events is a priceless tool used in many fields all over the world. Because weather can quickly change and have especially devastating effects on those occupying marine vehicles in bodies of water, being able to accurately predict weather patterns over bodies of water is especially valuable for those participating in marine activities. Fisherman also use weather information to predict when and where they may have the most success catching a particular species of marine life. Weather ships were once used to observe temperature, humidity, wind, wave patterns, etc. of bodies of water to give other marine vehicles fair warning of quickly changing weather conditions. These were invaluable tools for predicting weather patterns for many years; however, their cost was relatively high compared to weather buoys, and the last weather ship was decommissioned in 2010. Now weather buoys are largely used in the place of weather ships, but weather buoys are not the most reliable due to frequent component malfunctions. Additionally, if a weather buoy becomes inoperable due to a malfunctioning component, it may be out of commission for a long time before it is repaired, meaning that those participating in marine activities may be without the valuable data produced by that particular weather buoy as long as it is down. This may be particularly devastating for fishermen who often use this data to plan their day.

Weather ships have survived in a way, however. The voluntary observing ship program allows crew from ships to observe weather at their specific geolocation. The crew of a voluntary observing ship measures environmental conditions, encodes each observation in a standard format, and sends the data over satellite or radio to the many national meteorological services that have responsibility for marine weather forecasting. However, there are only about four thousand ships worldwide that participate in this program, which is down from a peak of nearly eight thousand in the mid 1980s. Additionally, real time reports from the voluntary observing ships are heavily concentrated along the major shipping routes, primarily in the North Atlantic and North Pacific Oceans. The data collected in the oceans of the southern hemisphere was already sparse before the decline in ships participating in the voluntary observing ship program, which makes it more essential that ships in these areas collect and report environmental data to help enhance the forecast and warning services available to mariners. Regardless, the few ships that do collect data are so sparse that it often provides little value to fisherman.

Fisherman participate in fishing activities throughout the year in a variety of geolocations and under a variety of environmental conditions that affect catch outcomes. For many, this is a daily activity, meaning they are often in position to collect valuable data that may be used to predict weather patterns and optimal fishing locations. Collecting this data would be especially valuable for fisherman for a variety of reasons. For instance, because weather patterns can change so quickly around bodies of water, fisherman can easily find themselves in a dangerous situation with no form of shelter besides a boat that may be overwhelmed by extreme conditions. This can result in damage to the fisherman's marine vehicle, injury to the fisherman, or even loss of life. For instance, a fisherman may have a variety of favorite fishing locations. Generally, fishermen try to learn from experience in order to duplicate fishing success and minimize failure. However, because there are so many variables related to fishing success, it can be difficult for most fishermen to track variables and notice trends in order to optimize fishing success. This may result in reduced success for the fisherman, which may result in loss of income or a loss of enjoyment of participating in the activity.

When fishermen do have success, they may or may not wish to share information related to their success with other fishermen in order to minimize competition. This is particularly true for specific fishing locations, which a fisherman may keep secret so that they may more or less keep the location to themselves. On the other hand, some fishermen may wish to share such information with close friends even if they are unwilling to share that information with potential competition. Regardless, it may be difficult to accurately pinpoint a fishing location to another person without showing that person the location on a map or providing coordinates. Even that can be confusing because a high degree of accuracy may be needed to accurately describe a fishing location. This may or may not be provided by simply trying to point out a location on a map. Additionally, sharing a location without sharing information regarding to specific lures or baits may result in different outcomes for the person fishing the same location using different lures or baits.

Accordingly, there is a need in the art for a system and method for managing information related to marine activities so that information may be shared in a manner that will increase the safety and enjoyment of the marine activities.

### SUMMARY

A system and method for managing information related to marine activities and selectively sharing such information is provided. The system and method of the present disclosure are directed towards recording and managing data relevant to various marine activities. More generally, the system and method of the present disclosure are designed to easily and conveniently compile and store information or data related to fishing, including, but not limited to, environmental conditions experienced, fishing equipment used, and species of marine life caught. Such data may include photos or videos of the fish caught, geolocations where the fish was caught, species of fish caught, weight and/or length of fish caught, baits and/or lures used to catch the fish, and environmental conditions under which the fish was caught, such as turbidity, barometric pressure, temperature, humidity, light conditions, tide conditions, and lunar data. Once the information is compiled and stored, a user may selectively share all or parts of the information with other users. The system is also designed to collect environmental data and create buoy profiles that may be used by other users to scout environmental conditions that may be conducive to catching certain fish in certain geolocations. These buoy profiles may be updated in real time by fisherman using the system in a way such that the system provides users with large amounts of accurate weather data. The system may also be used to alert users of dangerous weather conditions as well as alert users of optimal marine activity locations based on the buoy profiles. For instance, a user may use the system to find a location having optimal environmental conditions for windsurfing.

The system uses at least one sensor to monitor and record environmental data. When environmental data has been measured and transmitted to the processor, the environmental data may be combined in a way that transforms the environmental data into a buoy profile. For instance, a system comprising a GPS, barometer, wind transducer, turbidity sensor, light sensor, and water/air thermometer may have a buoy profile comprising geospatial data, barometric pressure data, wind data, light scattering data, and water/air temperature data. Once the buoy profile has been created, the processor may save the buoy profile to the non-transitory computer-readable medium. In an embodiment, a plurality of buoy profiles may be stored within the non-transitory computer-readable medium of the system. Alternatively, the system may store the plurality of buoy profiles within a database wherein each buoy profile within the plurality of buoy profiles may contain information specific to the environmental conditions at a certain geolocation. These buoy profiles may be used by the system to determine whether a dangerous environmental condition is near a user's geolocation. If the system may display environmental conditions within the application of the mobile device using indicia.

A user may connect and subsequently upload data or information related to a marine activity to a host site, preferably using a mobile device such as a smartphone. The user may access the host site through an application, which may be programmed to automatically upload certain data related to marine activities, such as geospatial data, environmental data, and activity data. The system may comprise hardware, software, or firmware components to facilitate ease and convenience of uploading and organizing marine activity data. For instance, the system may comprise software operably linked to a camera of a mobile device. When a user catches a fish, the user may take a photo of the fish using the camera. The photo may then be uploaded to a database automatically via the software and the meta data may be extracted. The system may identify the species of fish using a machine learning technique, which may also be added to the activity profile. In an embodiment, the application may be programmed to automatically and simultaneously upload geospatial data when uploading the photo to indicate the geolocation where the fish was caught. In addition, the mobile device may be connected to a network, and the application may be programmed to automatically scan the network to obtain contemporaneous fishing-related data based on the geospatial data. For instance, when a digital photo is take of a fish using mobile device via the application, the system may perform a search for contemporaneous fishing-related data, such as tide condition data and lunar data. This information may be stored in the database, wherein the user may choose to share the information with a community of users on a social network or selectively share the information with specific users. The system may also use this information to alert users of optimal fishing conditions.

In an embodiment, the system may further comprise marine equipment each having an equipment transmitter, such as an infrared transmitter (IR) or similar identifier, either embedded within the marine equipment or contained in packaging in which the marine equipment is sold. The system has an equipment sensor that may be used to read a signal broadcast by the equipment transmitter. In an embodiment, the system is configured to identify the marine equipment and record data related to the marine equipment using the equipment transmitter and equipment sensor. When embedded within the marine equipment itself, a user may bring the marine equipment in close proximity to the mobile device so that the mobile device detects which marine equipment is currently being used by the user. The system may pair this equipment with the user for a period of time until a different piece of marine equipment is tagged or a user deselects the equipment in the application. For instance, a user may bring a lure having an equipment sensor in close proximity to a mobile device, which may inform the system that the particular lure is being used. Any photograph of a marine species captured while the system associates the user with that particular lure will automatically be associated with that lure. Data relating to the lure used to catch the fish may then be uploaded and associated with all other data relating to that particular fish. For instance, when embedded in packaging containing a purchased lure, the user may tag or scan the lure packaging in the same manner to create a personal list of lures that may be stored in the database. A user may then optionally select a lure from the list to associate with a particular fish caught.

In another embodiment, the system may further comprise a scale operably connected to the mobile device and configured to function with the application. When a species of marine life is caught, the marine life may be weighed using the scale. Once a weight is determined, the scale is configured to transmit the data to the application of the mobile device. This transfer is preferably performed wirelessly utilizing Bluetooth or similar wireless technology. Therefore, in some embodiments, the mobile device further comprises a wireless device. The weight of the marine life may be uploaded to the database as part of a compendium of data, including a photo of the marine life and any data automatically uploaded by the system.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is an illustrative screen shot of a computer application consistent with the principles of the present disclosure.

FIG. 3 is an illustrative screen shot of a computer application consistent with the principles of the present disclosure.

FIG. 4 is a diagram illustrating the manner in which individual access to data may be granted or limited based on user or system roles.

FIG. 5 is a flow chart illustrating certain method steps of a method embodying features consistent with the principles of the present disclosure.

FIG. 6 is a flow chart illustrating certain method steps of a method embodying features consistent with the principles of the present disclosure.

FIG. 7 is a flow chart illustrating certain method steps of a method embodying features consistent with the principles of the present disclosure.

FIG. 8 is a flow chart illustrating certain method steps of a method embodying features consistent with the principles of the present disclosure.

FIG. 9 is a flow chart illustrating certain method steps of a method embodying features consistent with the principles of the present disclosure.

FIG. 10 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “created vector” and grammatical equivalents refers to the one or more vectors created by the processor based on the mapped activation levels of the one or more sensors.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As will be evident from the disclosure provided below, the present invention satisfies the need for a system and method capable of managing data related to marine vehicles without human intervention, and thereby improving upon known systems currently employed within the art.

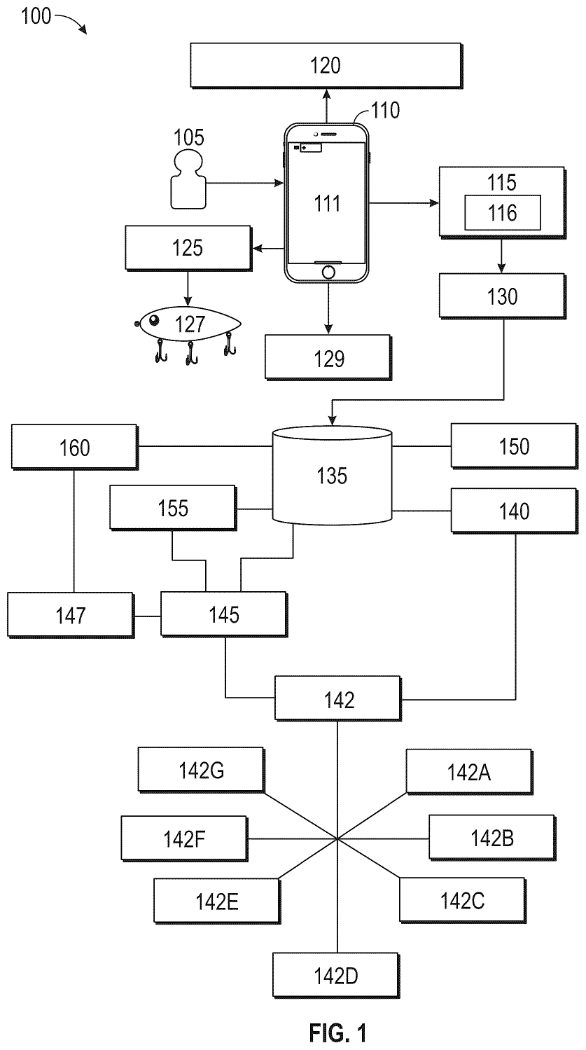

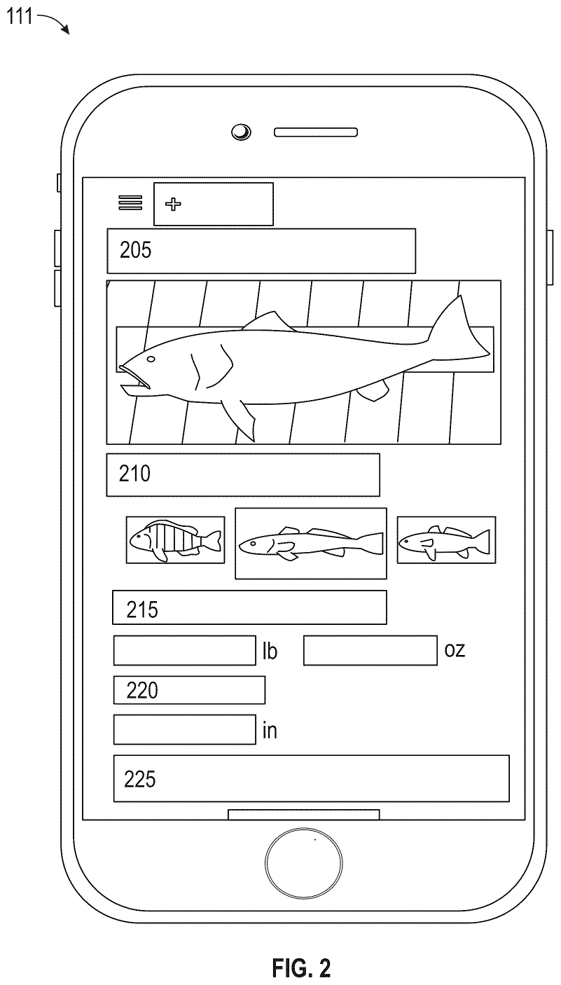

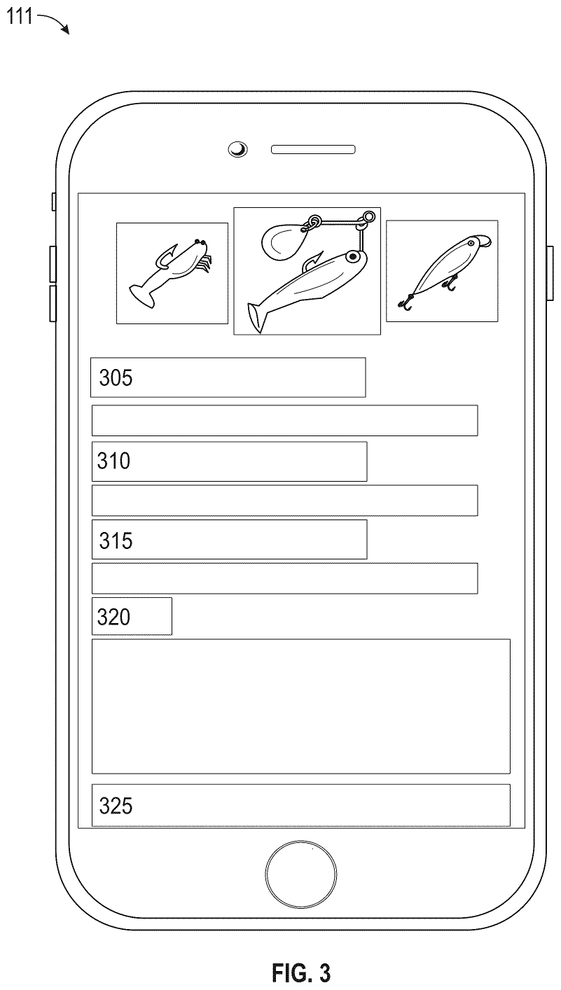

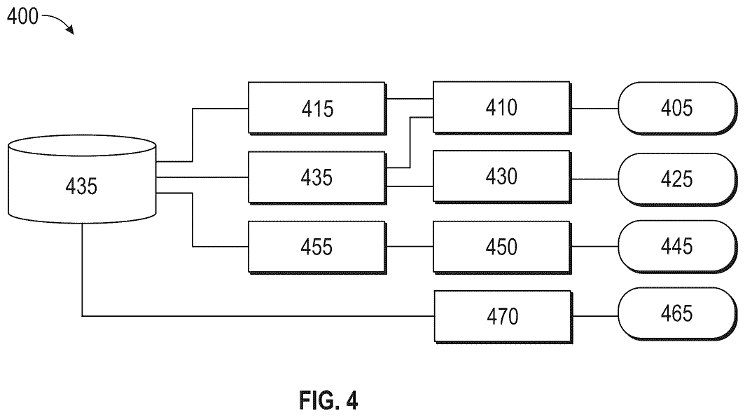

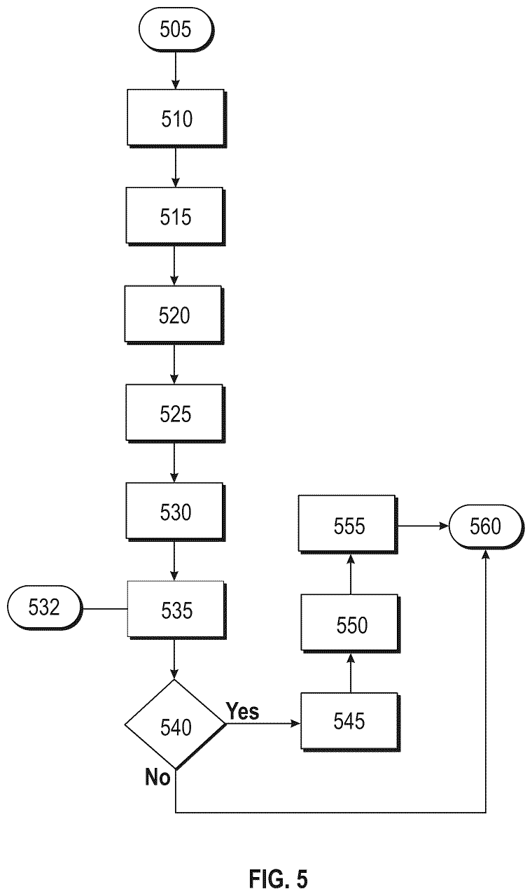

FIGS. 1-9 illustrate embodiments of a system 100 for managing information related to marine activities. FIG. 1 shows an embodiment of the disclosed system 100. As shown in FIG. 1, the system 100 generally comprises at least one sensor 120, a processor 115 operably connected to the at least one sensor 120, a power supply, a display operably connected to the processor 115, a non-transitory computer-readable medium 116 coupled to the processor 115 and having instructions stored thereon, and a database 135 operably connected to the processor 115. In one embodiment, a computing device 110 having a user interface 111 may be operably connected to the processor 115. In another embodiment, a server 130 may be operably connected to the database 135 and processor 115, facilitating the transfer of information between the processor 115 and database 135. In yet another embodiment, a scale 129 may be operably connected to the database 135 and processor 115. In yet another embodiment, an equipment sensor 125 may be operably connected to the database 135 and processor 115. The equipment sensor 125 may track marine equipment 127 added or removed from system 100. In yet another embodiment, a security system may be operably connected to the database 135 and processor 115. It is understood that the various method steps associated with the methods of the present disclosure may be carried out as operations by the system 100 shown in FIG. 1. FIGS. 5-10 shows various methods that may be carried out by the system 100. FIGS. 2 and 3 illustrate example screenshots of a user interface 111 that may be displayed via a computing device 110 such as a mobile phone. FIG. 4 illustrates permission levels 400 that may be utilized by the present system 100 for controlling access to user content 415, 435, 455.

The at least one sensor 120 may be secured on a marine vehicle in a way such that it may measure environmental conditions of the marine vehicle and transmit environmental data to the processor 115. An environmental condition may be defined as external conditions experienced by a marine vehicle. Types of sensors that may be used as an at least one sensor 120 include, but are not limited to, a global positioning system (GPS), barometer, accelerometer, gyroscope, camera, light sensor, electronics sensor, thermometer, humidity sensor, turbidity sensor, lightning sensor, microphone, engine monitor, radar, wind transducer, compass, depth transducer, and speed transducer, or any combination thereof. For instance, a system 100 comprising an at least one sensor 120 comprising a barometer, lighting sensor, and depth transducer may measure barometric pressure data 142F, lightning strike data, and depth data 142A and transmit that data to the processor 115. Therefore, the at least one sensor 120 may measure a variety of types of environmental data and transmit that data to the processor 115.

Alternatively, the system 100 may receive data from an at least one sensor 120 connected to a National Marine Electronics Association (NMEA) device. In an embodiment, types of sensors that may be connected to a NMEA device may include, but are not limited to, a GPS, barometer, accelerometer, gyroscope, camera, light sensor, electronics sensor, thermometer, humidity sensor, turbidity sensor, lightning sensor, microphone, engine monitor, radar, wind transducer, compass, depth transducer, and speed transducer, or any combination thereof. In another embodiment, an equipment sensor 125, scale 129, and security system may be operably connected to the NMEA device as well. The processor 115 may be operably connected to the NMEA device in a way such that information may be transmitted to the processor 115 from the at least one sensor 120 connected to the NMEA device. The processor 115 may then use this information to perform the various functions of the system 100. For instance, a system 100 operably connected to a NMEA device with a wind transducer may transmit wind data that the processor 115 may use to create a buoy profile 140 for the system 100. For instance, a system 100 operably connected to a NMEA device with an equipment sensor 125 may transmit equipment data that the processor 115 may use to create an activity profile 145 for the system 100.

The processor 115 is configured to perform the operations disclosed herein based on instructions stored within the system 100. The processor 115 may process instructions for execution within computing device 110, including instructions stored in memory or on a storage device, to display graphical information for a graphical user interface (GUI) on an external input/output device, such as a display. The processor 115 may provide for coordination of the other components of a computing device 110, such as control of user interfaces 111, applications run by a computing device 110, and wireless communication by a communication device of the computing device 110. The processor 115 may be any processor or microprocessor suitable for executing instructions. In some embodiments, the processor 115 may have a memory device therein or coupled thereto suitable for storing the data, content, or other information or material disclosed herein. In some instances, the processor 115 may be a component of a larger computing device 110. A computing device 110 that may house the processor 115 therein may include, but are not limited to, laptops, desktops, workstations, personal digital assistants, servers, mainframes, cellular telephones, tablet computers, or any other similar device. Accordingly, the inventive subject matter disclosed herein, in full or in part, may be implemented or utilized in devices including, but are not limited to, laptops, desktops, workstations, personal digital assistants, servers, mainframes, cellular telephones, tablet computers, or any other similar device.

In an embodiment, the programming instructions responsible for the operations carried out by the processor 115 are stored on a non-transitory computer-readable medium (“CRM”) 116, which may be coupled to the server 130, as shown in FIG. 1. Alternatively, the programming instructions may be stored or included within the processor 115. Examples of non-transitory computer-readable mediums include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions may be stored as modules within the non-transitory computer-readable medium.

Once environmental data has been measured and transmitted to the processor 115, the environmental data may be combined in a way that transforms the environmental data into a buoy profile 140, which may be viewed within a user interface 111. As such, a buoy profile 140 represents a snapshot of the environmental conditions at a specific geolocation at a particular time. For instance, a system 100 comprising a GPS, barometer, wind transducer, turbidity sensor, light sensor, and water/air thermometer may have a buoy profile 140 comprising geospatial data 142G, barometric pressure data 142F, wind data, light scattering data 142E, and water/air temperature data 142C. Additionally, the buoy profile 140 may comprise fewer environmental data points than may be measured by the at least one sensor 120. For instance, a marine vehicle comprising a water/air thermometer, hygrometer, and wind transducer collecting water/air temperature data 142C, humidity data 142B, and wind speed data 142D may have a buoy profile 140 comprising wind data 142D and water/air temperature data 142C. As such, one with skill in the art will recognize that a buoy profile 140 may comprise a number of different combinations of data without departing from the inventive subject matter as described herein. Once the buoy profile 140 has been created, the processor 115 may save the buoy profile 140 to the non-transitory computer-readable medium 116. In an embodiment, a plurality of buoy profiles 140 may be stored within the non-transitory computer-readable medium 116 of the system 100. Alternatively, the system 100 may store the plurality of buoy profiles 140 within a database 135 wherein each buoy profile 140 within the plurality of buoy profiles 140 may contain information specific to the environmental conditions at a certain geolocation.

In an embodiment, the at least one sensor 120 comprises a GPS so that the processor 115 may receive geospatial data 142G in a way that causes any subsequently created buoy profile 140 to contain that geospatial data 142G. Alternatively, a user 105 may manually input geospatial data 142G corresponding to a specific geolocation into a buoy profile 140. For instance, a system 100 comprising a computing device 110 having a user interface 111 may allow a user 105 to input geospatial data 142G using an input device such as a keyboard. For instance, a system 100 comprising a computing device 110 having a touch screen and a user interface 111 comprising a graphic information system (GIS) may allow a user 105 to select the geolocation on a map displayed via the touchscreen. As used herein, geospatial data 142G may be spatial data including, but not limited to, numeric data, vector data, and raster data, or any combination thereof. Numeric data may be statistical data which includes a geographical component or field that can be joined with vector files so the data may be queried and displayed as a layer on a map in a GIS. Vector data may be data that has a spatial component, or X, Y coordinates assigned to it. Vector data may contain sets of points, lines, or polygons that are referenced in a geographic space. Raster data may be data in a .JPG, .TIF, .GIF or other picture file format. For instance, a map scanned in a flatbed scanner may be considered raster data.

In an embodiment, the system 100 may further comprise a computing device 110 operably connected to the processor 115. A computing device 110 may be implemented in a number of different forms, including, but not limited to, servers, multipurpose computers, mobile computers, etc. For instance, a computing device 110 may be implemented in a multipurpose computer that acts as a personal computer for a user 105, such as a laptop computer. For instance, components from a computing device 110 may be combined in a way such that a mobile computing device is created, such as mobile phone. Additionally, a computing device 110 may be made up of a single computer or multiple computers working together over a network. For instance, a computing device 110 may be implemented as a single server or as a group of servers working together over and Local Area Network (LAN), such as a rack server system 100. Computing devices 110 may communicate via a wired or wireless connection. For instance, wireless communication may occur using a Bluetooth, Wi-Fi, or other such wireless communication device. In addition, a GPS may provide geospatial data 142G to a computing device 110, which may be used as appropriate by applications running on the mobile computing device.

In an embodiment, as illustrated in FIG. 1, the computing device 110 is a mobile computing device. Mobile computing devices may include, but are not limited to, cellular telephones, smart phones, personal digital assistants, tablet computers, or other similar mobile computing devices. In an embodiment, computing devices 110 may communicate audibly, meaning computing devices 110 may transmit and receive information via sound waves and covert the sound waves into digital information. For instance, a user 105 may instruct a user interface 111 of a computing device 110 with their voice to perform a certain action. The processor 115 may convert the sound waves of the user 105 into instructions, which the processor 115 may then carry out. Computing devices 110 may likewise generate audible sound for a user 105, such as through an audio device. Such sound may include sound from voice telephone calls, recorded notes, voice messages, music files, etc. Audible sounds may also include sound generated by applications operating on a computing device 110. For instance, an application running on a mobile computing device may be configured in a way such that when a certain condition is met the application causes the mobile computing device to output a sound. For instance, an application may be configured in a way such that an alarming sound is emitted via an audio device connected to the computing device 110 at a certain time of day. For instance, the processor 115 may receive a signal indicating that the environmental conditions are conducive to fishing in a particular geolocation. The processor 115 may then convert this signal into an audio message that may be sent to an audio device to make the user 105 aware of the favorable conditions.

In an embodiment, the system 100 may further comprise a user interface 111. A user interface 111 may be defined as a space where interactions between a user 105 and the system 100 may take place. In an embodiment, the interactions may take place in a way such that a user 105 may control the operations of the system 100. A user interface 111 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, or any combination thereof. The system 100 may present data of the user interface 111 to the user 105 via a display operably connected to the processor 115. A display may be defined as an output device that communicates data that may include, but is not limited to, visual, auditory, cutaneous, kinesthetic, olfactory, and gustatory, or any combination thereof.

Information presented via a display may be referred to as a soft copy of the information because the information exists electronically and is presented for a temporary period of time. Information stored on the non-transitory computer-readable medium 116 may be referred to as the hard copy of the information. For instance, a display may present a soft copy of visual information via a liquid crystal display (LCD), wherein the hardcopy of the visual information is stored on a local hard drive. For instance, a display may present a soft copy of audio information via a speaker, wherein the hard copy of the audio information is stored on a flash drive. For instance, a display may present a soft copy of tactile information via a haptic suit, wherein the hard copy of the tactile information is stored within a database 135. Displays may include, but are not limited to, cathode ray tube monitors, LCD monitors, light emitting diode (LED) monitors, gas plasma monitors, screen readers, speech synthesizers, haptic suits, speakers, and scent generating devices, or any combination thereof.

In an embodiment, the processor 115 may receive the plurality of buoy profiles 140 so that they may be mapped within a user interface 111 and presented to the user 105 via a display. In an embodiment, a geographic information system (GIS) of the user interface 111 may be used to map the plurality of buoy profiles 140. A GIS may be defined as a computer system for capturing, storing, checking, and displaying data related to positions on the Earth's surface. A GIS can use any information that includes location. The location can be expressed in many different ways, such as latitude and longitude, address, or ZIP code. Many different types of information may be compared and contrasted when using a GIS. The system 100 may include data about marine vehicle traffic, the locations of streams, different kinds of vegetation, and the direction of water currents. It may include information about the sites of factories, farms, storm drains, roads, electric power lines, and underwater features such as bathymetry or sunken man-made features.

Buoy profiles 140 may be represented within the user interface 111 by indicia. The indicia used to represent a buoy profile 140 may depend on the environmental data collected by the system 100. For instance, a system 100 having a wind transducer that measures a high wind speed at a particular geolocation may have a buoy profile 140 represented by an indicia indicative of high winds. For instance, a system 100 having a light sensor and hygrometer that measure an ambient light level and relative humidity level indicative of fog at a particular geolocation may have a buoy profile 140 represented by an indicia signifying fog. Additionally, an indicia may be representative of more than one type of environmental condition. For instance, a system 100 having a barometer, hygrometer, and lightening sensor measuring a barometric pressure, relative humidity level, and flashes of light indicative of rain and lightning strikes may have a buoy profile 140 represented by an indicia signifying rain and lightning. The data is preferably updated in the real time, so the system 100 may provide users 105 participating in marine activities with information regarding environmental conditions at a specific geolocation in real time.

In an embodiment, the user interface 111 of a computing device 110 may also present raw environmental data of a buoy profile 140 via a display. Because the types of data contained within a buoy profile 140 may differ depending on the type of at least one sensor 120 used to collect the environmental data for the system 100, the environmental data displayed within the user interface 111 may differ among the plurality of buoy profiles 140. Additionally, the user interface 111 may be programmed to display only certain types of environmental data. For instance, the computing device 110 may be programmed to only displaying information related to air temperature, water temperature, wind speed, wind direction, and relative humidity despite the buoy profile 140 also containing information relating to ambient light, barometric pressure, and engine performance. In an embodiment, a user 105 may interact with the buoy profile within the user interface 111 in a way such that environmental data of the buoy profile 140 may be displayed or hidden. For instance, a user 105 may interact with a displayed buoy profile 140 via a touch screen of a mobile computing device in a way such that the interaction causes the processor 115 to instruct the user interface 111 to present the environmental data of the buoy profile 140 via a display. For instance, a user 105 may interact with displayed environmental data of a buoy profile 140 via a touch screen of a mobile computing device in a way such that the interaction causes the processor 115 to instruct the user interface 111 to hide the environmental data of the buoy profile 140 so that only the buoy profile 140 is visible within the user interface 111.

In another embodiment, the computing device 110 may be used to input activity data 147 for the creation of an activity profile 145. As shown in FIG. 1, activity data 147 may include various types information related to marine activities. Types of activities that may be represented by activity data 147 may include, but is not limited to, fishing, water skiing, diving, snorkeling, surfing, windsurfing, kite boarding, and parasailing. The type of activity data 147 input via the user interface 111 may depend on the type of marine activity. For instance, a marine activity involving fishing may have activity data 147 that includes, but is not limited to, fishing equipment used and digital images 205 or videos of marine life 210 caught. For instance, a marine activity involving diving may have activity data 147 that includes, but is not limited to, digital images 205 or videos of marine life 210 seen, the depth at which that marine life 210 was located, and the geolocation at which that marine life 210 was located. In yet another embodiment, a tournament catch log 160 may contain activity data that the system 100 may use to create an activity profile 145. For instance, a user 105 may log data regarding catches during a fishing tournament using a computing device 110 connected to a database 135. The system 100 may be connected to the database 135 containing the tournament catch log 160 in a way such that the system 100 may use that tournament catch log 160 to create an activity profile 145.

Activity data 147 may be uploaded and/or input to the database 135 via the user interface 111 automatically or manually by the user 105. In an embodiment, activity data 147 may be automatically uploaded and stored in the database 135. For instance, a digital image 205 of marine life 210 uploaded by a user 105 when the marine life 210 is caught may be automatically stored within a database 135. In an embodiment, when a digital image 205 is received by the processor 115, the processor 115 may also receive environmental data from the at least one sensor 120. For instance, the system 100 may receive time data and geospatial data 142G from a time keeping device and a GPS when a digital image 205 is received by the processor 115. Once the activity profile 145 has been created, the processor 115 may save the activity profile 145 to the non-transitory computer-readable medium 116. In an embodiment, a plurality of activity profiles 145 may be stored within the non-transitory computer-readable medium 116 of the system 100. Alternatively, the system 100 may store the plurality of activity profiles 145 within a database 135, wherein each activity profile 145 within the plurality of activity profiles 145 may contain information specific to a marine activity at a certain geolocation.

As used herein, a database 135 refers to a set of related data and the way it is organized. Access to this data is usually provided by a database management system (DBMS) consisting of an integrated set of computer software that allows users 105 to interact with one or more databases 135 and provides access to all of the data contained in the database 135. The DBMS provides various functions that allow entry, storage and retrieval of large quantities of information and provides ways to manage how that information is organized. Because of the close relationship between the database 135 and the DBMS, as used herein, the term database 135 refers to both a database and DBMS.

As shown in FIG. 1, the database 135 is configured to store data relating to marine activities therein, which may include environmental data and activity data 147. The database 135 may also be configured to store marker data of marker profiles, including, but not limited to, tournament data, live bait data, charter data, and boat share data, or any combination thereof. The processor 115 may be operably connected to the database 135 via wired or wireless connection. The database 135 may be a relational database such that the environmental data, activity data 147, and marker data associated with each buoy profile 140, activity profile 145, and marker profile 150 within the plurality of buoy profiles 140, plurality of activity profiles 145, and plurality of marker profiles 150 may be stored, at least in part, in one or more tables. Alternatively, the database 135 may be an object database such that the environmental data, activity data 147, and marker data associated with each buoy profile 140, activity profile 145, and marker profile 150 within the plurality of buoy profiles 140, plurality of activity profiles 145, and plurality of marker profiles 150 are stored, at least in part, as objects. In some instances, the database 135 may comprise a relational and/or object database and a server 130 dedicated solely to managing the content assigned to profiles in the manner disclosed herein.

As mentioned previously, the system 100 may further comprise a server 130. A server 130 may be a search server, a document indexing server, and general web server. Servers 130 may be separate entities performing different functions or similar functions. For instance, two or more servers 130 may be implemented to work as a single server 130 performing the same tasks. Alternatively, one server 130 may perform the functions of multiple servers 130. For instance, a single server 130 may perform the tasks of a web server and an indexing server. Although represented as a single server in FIG. 1, it is understood that multiple servers may be used to operably connect the processor 115 to the database 135 and/or the content repositories. The processor 115 may be operably connected to the server 130 via wired or wireless connection. Search servers may include one or more computing devices 110 designed to implement a search engine, such as a documents/records search engine, general webpage search engine, etc. Search servers may, for example, may include one or more web servers to receive search queries and/or inputs from users 105, search one or more databases 135 in response to the search queries and/or inputs, and provide documents or information, relevant to the search queries and/or inputs, to users 105. In some implementations, search servers may include a web search server that may provide webpages to users 105, where a provided webpage may include a reference to a web server at which the desired information and/or links is located. The references, to the web server at which the desired information is located, may be included in a frame and/or text box, or as a link to the desired information/document.

Document indexing servers may include one or more computing devices 110 designed to index documents available through networks. Document indexing servers may access other servers 130, such as web servers that host content, to index the content. In some implementations, document indexing servers may index documents/records stored by other servers 130 connected to the network. Document indexing servers may, for example, store and index content, information, and documents relating to user 105 accounts and user-generated content. Web servers may include servers 130 that provide webpages to clients. For instance, the webpages may be HTML-based webpages. A web server may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

Once the activity data 147 has been received by the processor 115, the processor 115 may receive environmental data from the at least one sensor 120 and combine the environmental data in a way that transforms the environmental data into an environmental state 142. An environmental state 142 represents the weather conditions at the time the activity data 147 was received by the processor 115. Activity data 147 and the environmental state are combined by the processor 115 in a way that transforms the activity data 147 and environmental state into an activity profile 145, which may be viewed within a user interface 111. As such, an activity profile 145 represents a glimpse of weather conditions experienced while enjoying a marine activity at a particular time and place. In an embodiment, the activity profile 145 may be transmitted by the processor 115 to a database 135 containing a plurality of activity profiles 145. The processor 115 may receive the plurality of activity profiles 145 from the database 135 so that they may be mapped within the user interface 111. In an embodiment, a GIS of the user interface 111 may be used to map the plurality of activity profiles 145. In another embodiment, the activity profiles 145 may be represented within the user interface 111 by indicia. The indicia used to represent an activity profile 145 may depend on the marine activity participated in. For instance, an activity profile 145 containing information related to the marine activity of fishing may be represented by an indicia signifying fishing. Additionally, an indicia may signify multiple aspects of a marine activity. For instance, an activity profile 145 containing information related to catching a bonefish using fly fishing equipment may be represented by an indicia signifying fly fishing and bonefish. For instance, an activity profile 145 containing information related to catching a redfish using bait caster equipment may be represented by an indicia signifying bait casting and redfish. In this way, the system 100 may provide users 105 with visual information regarding an activity profiles 145 displayed within a user interface 111 without having to look at the data within the plurality of activity profiles 145.

In an embodiment, the system 100 may determine a species of marine life 210 from a digital image 205 taken by a user 105. For instance, a user 105 participating in the marine activity of diving may take a picture of marine life 210, and the system 100 may automatically determine the species of the marine life 210 for the user 105 via digital signal processing. In an embodiment, the system 100 may use a machine learning technique to determine a species of marine life 210 within a digital image. For instance, pattern recognition or feature extraction may be used to determine the species of a marine life 210 within a digital image. Pattern recognition methods may use labeled data that the system 100 may match to a digital image 205 using algorithms to determine a species of marine life 210. Feature extraction methods may use algorithms to detect and isolate various desired portions or shapes of a digital image 205 to determine a species of marine life 210. Alternatively, the system 100 may use more than one machine learning technique to determine a species of marine life 210 from a digital image. For instance, if the system 100 fails to determine a species of marine life 210 using pattern recognition, the system 100 may subsequently attempt to determine a species of marine life 210 using feature extraction.

The system 100 may compare data from the captured digital image 205 relating to the general shape of the marine life 210, the color of the marine life 210, and/or markings on the marine life 210, such as spots or stripes in various locations on the body of the marine life 210. When the species is detected by the system 100, the system 100 may automatically transmit the information to an activity profile 145. However, because some species of marine life 210, particularly closely related species, may have a very similar physical appearance, the system 100 may provide the user 105 with a limited number of species options to choose from based on a comparison of the digital image 205 with species data in the database 135. In addition, the options of species to select from may also be limited based on geospatial data 142G and habitat range data associated with identified species contained within the database 135, as previously described, though a user 105 may override the provided species list to choose from any species contained within the database 135. Thus, the user 105 may optionally select a different species than an automatically detected species, and this information may then be associated with a digital image 205 of marine life 210 or group of marine life data. In an embodiment, the user 105 may optionally skip the step of capturing a digital image 205 of the marine life 210 and simply select the species from a list as previously described. Alternatively, the user 105 may choose to skip the step of capturing a digital image 205 of the marine life 210 and simply select the species from the list as previously described.

In addition, the system 100 may be programmed to automatically detect the length 220 of marine life 210 within a digital image. For instance, the user interface 111 may comprise of an application that allows for the capture of digital images. The digital image 205 capturing application of the user interface 111 may comprise a built-in digital measurement ruler having labeled length markings at defined intervals that may be used to measure the length 220 of marine life 210 within a digital image. In an embodiment, the user 105 may hold the computing device 110 used to make the digital image 205 a specified distance from the marine life 210 before the digital image 205 is taken using the user interface 111. For instance, the camera may be held approximately two meters away from the species of marine life in order to get a length 220 determination by the system 100. By taking the digital image 205 at the specified distance, the system 100 may use the measurement ruler as a point of reference in which to estimate the length 220 of the marine life 210 within the digital image. In an embodiment, the user 105 may choose to make the digital measurement ruler visible or not visible within the user interface 111. Alternatively, the system 100 may determine the length 220 of the marine life 210 by determining the shape and size of the marine life 210 in the digital image 205 and performing a relative size analysis to determine the length 220 of the marine life 210. During a relative size analysis, the system 100 may compare the size and shape of the marine life 210 taken at a specific distance to that of the size and shape of an object taken at the same specific distance and having a known size. The system 100 may then determine the size of the marine life 210 within the digital image 205 by using the object as a point of reference.

In addition to buoy profiles 140 and activity profiles 145, the system 100 may further comprise marker profiles 150. A marker profile 150 may be defined as a profile containing data relevant to the participation in marine activities other than buoy profiles 140 and activity profiles 145. For instance, a marker profile 150 may comprise of information relating to charter boats, boat sharing, and live bait vendors. A marker profile 150 pertaining to charter boats may contain information relevant to the cost and availability of a charter boat at a particular geolocation. For instance, a user 105 creating a marker profile 150 pertaining to charter boats may advertise charters to other users 105 and manage charter scheduling through the user interface 111. In an embodiment, the user interface 111 may be configured in a way such that a user 105 may search for a charter boat and/or pay for a charter boat using the marker profiles 150 pertaining to charter boats. For instance, a user 105 wanting to charter a boat for parasailing at a particular geolocation may use a search function within the user interface 111 to search for charter boats for parasailing within five kilometers of that geolocation. In another embodiment, the user interface 111 may be configured to allow a user 105 to pay for the charter boat and other costs associated with the charter boat through the user interface 111. For instance, payment options through the interface may include the option of tipping the captain of the boat or deckhands a specified amount.

A marker profile 150 pertaining to boat sharing may contain information relevant to sharing a boat with other users 105 based on specified criteria, such as geolocation, marine vehicle type, or number of people that may participate in the marine activity. For instance, a user 105 creating a marker profile 150 pertaining to boat sharing for a scuba diving trip may manage information related to time, place, and the number of other users 105 that may participate in the trip, as well as manage the trip itself. In an embodiment, the user interface 111 may be configured in a way such that a user 105 wanting to participate in a marine activity with other users 105 may search the marker profiles 150 pertaining to boat sharing for a marine activity based on specified criteria. The user 115 may then choose a function that may allow the user 115 to book a spot for that particular marine activity. In one embodiment, selection of the function causes the user interface 111 causes the system 100 to perform a query to determine if there is available space for the user 115 to participate in a marine activity of a marker profile 150. If there is an available space, the system may 100 update user information within the marker profile 150. If there is not an available space, the system 100 may alert the user 115 that the particular marine activity the user 115 was interested in is unavailable. For instance, a user 105 wanting to search for another user 105 sharing their marine vehicle to go scuba diving with a group of five or more people at a particular geolocation may use a search function within the user interface 111 to search for a user 105 sharing their marine vehicle to go scuba diving with at least five or more people at that particular geolocation. The user 115 may then select a “book it” function within the user interface 111 that will hold the user's 115 spot for that particular marine activity if a spot is available. Thus, a user 105 without a marine vehicle may connect with other users 105 who have a marine vehicle in order to share costs of a marine activity, as well as to socialize with other users 105 with similar interests.

A marker profile 150 pertaining to live bait vendors may contain information relevant to live bait at a particular geolocation available for purchase by a user 105. In an embodiment, the user interface 111 may be configured in a way such that a user 105 may search for live bait and/or pay for live bait using the marker profiles 150 pertaining to live bait. For instance, on busy fishing days, a marina or bait shop may run out of live bait. A user 105 may search the marker profiles 150 pertaining to live bait for marinas selling live bait and may view a current live bait status for the marinas before driving to the marinas. If a chosen marina currently has live bait for sale, the user 105 may purchase the live bait through the user interface 111 and a participating marina may set aside a specified quantity of live bait for the user 105 until the user 105 arrives at the marina. In an embodiment, the purchase of live bait through the user interface 111 may produce a bar code that may be displayed within the user interface 111 of the user's 105 computing device 110. The user 105 may present the bar code to the marina upon arrival, and the marina may scan the code to complete the sale and indicate the quantity of live bait purchased. The bar code may prevent a user 105 from receiving more than one quantity of live bait in a single purchase.

As illustrated in FIG. 4, the system 100 may also comprise a plurality of permission levels 400 that may allow a user 105 to limit what data within their buoy profiles 140, activity profiles 145, and marker profiles 150 they share with another user 105. This data may be collectively known as content 415, 435, 455. To access the content 415, 435, 455 stored within the database, users 105 may be required to make a request via a user interface 111. Access to the content 415, 435, 455 within the database 135 may be granted or denied by the processor 115 based on verification of a requesting user's 405, 425, 445 permission level 400. If the requesting user's 405, 425, 445 permission level 400 is sufficient, the processor 115 may provide the requesting user 405, 425, 445 access to content 415, 435, 455 stored within the database 135. Conversely, if the requesting user's 405, 425, 445 permission level 400 is insufficient, the processor 115 may deny the requesting user 405, 425, 445 access to content 415, 435, 455 stored within the database 135. In an embodiment, permission levels 400 may be based on user roles 410, 430, 450 and administrator roles 470, as shown in FIG. 4. User roles 410, 430, 450 allow requesting users 405, 425, 445 to access content 415, 435, 455 that a user 105 has uploaded and/or otherwise obtained through use of the system 100. User roles 410, 430, 450 allow users 105 (or requesting users 405, 425, 445 authorized by the user 105) to access the user data tied to their own buoy profiles 140, activity profiles 145, and marker profiles 150 within the database 135. Administrator roles 470 allow administrators 465 to access system 100 wide data.

Alternatively, a requesting user 405, 425, 445 may gain a different permission level 400 by paying a fee. In one embodiment, the requesting user 405, 425, 445 may pay a general fee that may grant the requesting user 405, 425, 445 a permission level 400 that will allow the requesting user 405, 425, 445 to access other users'105 content 415, 435, 455. For instance, a requesting user 405, 425, 445 may pay a monthly fee of three dollars to access other users'105 content 415, 435, 455. In another embodiment, a requesting user 405, 425, 445 may pay a fee to a particular user for a permission level that will grant them access the particular user's 105 content 415, 435, 455. For instance, a requesting user 405, 425, 445 may pay a professional fisherman a monthly fee of five dollars to access their content 415, 435, 455. For instance, a fishing charter may allow a user 105 who paid for a charter fishing trip to access content 415, 435, 455 regarding that particular charter fishing trip. A requesting user 405, 425, 445 may pay for a higher permission level 400 using a Point of Sale system operably connected to the system 100. In an embodiment, the computing device 110 hosting a user interface 111 may be operably connected to the Point of Sale system in a way such that the Point of Sale system may communicate with the database 135 so that it alters the requesting user's 405, 425, 445 permission level 400. When a higher permission level 400 is purchased by the requesting user 405, 425, 445, the Point of Sale system may automatically communicate with the database 135 in a way such that it alters the permission level 400. In one embodiment, the user interface 111 may ask the requesting user 405, 425, 445 which content 415, 435, 455 the requesting user 405, 425, 445 would like to obtain from other users' 105 profiles.

In another embodiment, buoy profiles 140, activity profiles 145, and marker profiles 150 may be assigned to a user 105 in a way such that a user 105 may access such content via a user interface 111. In an embodiment, the system 100 may be configured to send a user 105 a notification indicating that another user 105 has shared information with the user 105. To access the data within a user's 105 buoy profiles 140, activity profiles 145, and marker profiles 150, a user 105 may make a user request via the user interface 111 to the processor 115. In an embodiment, the processor 115 may grant or deny the request based on the permission level 400 associated with the requesting user 105. Only users 105 having appropriate user roles 410, 430, 450 or administrator roles 470 may access the data associated with a user's 105 profile. For example, as illustrated in FIG. 4, data within buoy profiles 140, activity profiles 145, and marker profiles 150 assigned to requesting user 2's 425 content 435 may be selectively shared with requesting user 1 405 by granting requesting user 1 405 access to all of requesting user 2's 425 content 140. Alternatively, requesting user 2 425 may restrict access to content 430 in a way such that requesting user 1 405 may only access certain types of data within requesting user 2's 425 content 430. For example. Requesting user 2 425 may grant requesting user 1 405 access to environmental data and GPS data of an activity profile 145 but may restrict access to their equipment profiles 155 and activity profiles 145. In this instance, requesting user 1 405 may view content 415 of requesting user 2's 425 activity profile 145 concerning environmental data and activity data 147 but may not view content 415 concerning what equipment requesting user 2 425 used. For instance, a user 105 may selectively share information relating to a specific species of marine life 210 with other users 105. This information may include digital images 205 of the marine life 210 or may include other associated data, including the geolocation where the marine life 210 was caught and/or the marine equipment 127 on which the marine life 210 was caught.

The geolocation of activity profiles 145 of specific marine activities may also be selectively shared with a specified user 105 or group of users 105. For example, the system 100 may map a plurality of activity profiles 145 of a user 105 that pertain to the marine activity of fishing and display them on a computing device 110. The user 105 may select an activity profile on the map and view a list of all species of marine life 210 caught in that geolocation, as well as all data associated with each marine life 210 caught in a particular geolocation. This data may include all environmental data, such as humidity, temperature, tide conditions, time, and date, as well as activity data 147, such as a digital image 205 of the marine life 210 and the equipment used to catch the marine life 210. The user 115 may then choose within the user interface 111 to share or not share geolocation data pertaining to the selected activity profile 145. In this way, a user 105 may selectively choose which activity profiles 145 to share with other users 105 within a GIS of the user interface 111.

As mentioned previously, the system 100 may comprise a power supply. The power supply may be any source of power that provides the system 100 with electricity. In an embodiment, the power supply may be a twelve-volt power supply. The system 100 may connect to a NMEA device, which may act as the system's 100 power supply. Additionally, the system 100 may comprise of multiple power supplies that may provide power to the system 100 in different circumstances. For instance, the system 100 may be directly plugged into a stationary power outlet, which may provide power to the system 100 so long as it remains in one place. However, the system 100 may also be connected to a backup battery so that the system 100 may receive power even when the it is not connected to a stationary power outlet, such as those located at docks. In this way, the system 100 may always receive power so that it may continuously monitor the motion and environment of a marine vehicle regardless of location.

In another embodiment, the system 100 further comprises a scale 129 configured to operate within the user interface 111 of the computing device 110. When marine life 210 is captured by a user 105, the marine life 210 may be weighed using the scale 129. Once the weight 215 of the marine life 210 is determined, the scale 129 may be configured in a way such that the information may be transmitted to the processor 115. In an embodiment, the information may be transmitted wirelessly utilizing Bluetooth or similar wireless technology. In an embodiment, the transfer of information from the scale 129 to the processor 115 may be initiated automatically by opening the user interface 111 on the computing device 110 and weighing the marine life 210 using the scale 129. Alternatively, the user 105 may initiate transfer of the weight 215 of the marine life 210 from the scale 129 to the computing device 110 via an option within the user interface 111 that may be selected by the user 105. Selection of the option may cause the weight 215 dialogue box shown in FIG. 3 to automatically populate with the weight 215 of the marine life 210. The scale 129 may be used to determine the weight 215 of marine life 210 before or after photographing marine life 210. In situations where a user 105 decides not take a digital image 205 of the marine life 210, the user 105 may choose to transmit data from the scale 129 after the user 105 selects the species from a of species of marine life 210 as previously described. In another embodiment, the scale 129 may display the weight 215 of the species of marine life 210 in a way such that the weight 215 may be read from the digital image 205 using a machine learning technique. A user 105 may manually cause the system 100 to save the activity profile data by selecting a save function 325 within the user interface 111.

In yet another embodiment, the system 100 may further comprise at least one equipment sensor 125. The at least one equipment sensor 125 may be configured to detect marine equipment 127 having an equipment transmitter used during the marine activity and transmit marine equipment data to the processor 115. The equipment transmitter is preferably embedded in the marine equipment 127 and configured to broadcast a signal containing information relevant to that particular piece of marine equipment 127. In the embodiment in which an activity profile 145 is created from a digital image 205, the equipment sensor 125 may automatically transmit marine equipment data to the processor 115 for creation of an activity profile 145 and equipment profile 155. In another embodiment, the user 105 may bring a piece of marine equipment 127 having an equipment transmitter into close proximity with a computing device 110 having an equipment sensor 125 in a way such that he computing device 110 will recognize that the user 105 is currently using that particular piece of marine equipment 127. For instance, a user 105 may bring a lure fitted with a near field communication (NFC) transmitter into close proximity with a mobile device having an NFC sensor. The NFC sensor will alert a user interface 111 of the mobile device that the user 105 is currently using that particular lure. If the user 105 creates an activity profile 145 while the user interface 111 associates the user 105 with that particular lure, the lure data of the associated lure may be automatically added to the newly created activity profile 145. The system 100 may associate this particular piece of marine equipment 127 with the user 105 until the user 105 selects to dissociate the marine equipment 127 with themselves via a function of the user interface 111 or the system 100 is used to tag a new piece of marine equipment 127 that may replace the previous marine equipment 127. Alternatively, a user 105 may input marine equipment data manually. For instance, a user 105 may input lure type 225, reel type 305, rod type 310, and line type 315 where directed by the user interface 111 as illustrated in FIG. 3 using an input device, including, but not limited to, a keyboard or a touchscreen.

Once the marine equipment data has been received, the processor 115 may combine the marine equipment data with activity data 147 and the environmental state in a way that transforms the activity data 147, marine equipment data, and environmental state into an activity profile 145, which may be viewed within a user interface 111. For instance, a system 100 comprising a tackle box having an equipment sensor for detecting marine equipment 127 used while fishing (such as lures, rods, reels, hooks, line type, etc.) may be used to create an activity profile 145 when marine life 210 is caught and documented via a camera. When a user 105 takes a digital image 205 via the camera, the processor 115 may receive the marine equipment data from the tackle box and the environmental data from at least one sensor 120, as well as extract meta data from the digital image 205. This information may be combined in a way that transforms the data into an activity profile 145 related to the marine activity of fishing, wherein the activity profile 145 outlines the species of marine life 210, weather conditions, equipment used, and location of the catch. In some embodiments, activity profiles 145 may comprise of activity data 147 not including equipment data without departing from the inventive subject matter herein. Once activity profiles have been created, the system 100 may map the activity profile 145 within the user interface 111 and allow access to other users 105 using various permission levels 400. As shown in FIG. 3, other optional data may be input by the user 105 into a note 320 section presented within the user interface 111. This may be done before saving the activity profile 145 so that the information will be associated with activity profile 145. Notes 320 may include any optional information that the user 105 may want to remember, such as the degree of water clarity at the time of catching the marine life 210, which may be particularly relevant with respect to lure type 225 and the colors of lures used.

As shown in FIG. 1, marine equipment data may be stored separately within the database 135 from other activity data 147 in the form of an equipment profile 155. Alternatively, equipment profiles 155 may be stored on a separate dedicated server 130. Marine equipment data may include, but is not limited to, information relating to different types of marine equipment 127 that may be used for marine activities. Marine equipment data related to the marine activity of fishing may include the brand of the lure, lure type 225, color of the lure, size of the lure, rod type 310, length of rod, type of rod action, reel type 305, line type 315, etc. This information may specifically identify a particular equipment setup used to catch a particular species of marine life 210. As shown in FIG. 1, the equipment profile 155 may include data relating to a plurality of types of marine equipment 127 used for marine activities. Thus, a user 105 may store identifying information for all equipment used for a particular marine activity and access a personal list of equipment via the user interface 111 at any time.

In another embodiment, a security system may be operably connected to the processor 115, wherein the security system may transmit an alarm signal to alert a user 105. An alarm signal is preferably a computer readable signal that may be used to alert a user 105 of an event. In one embodiment, the alarm signal may cause the processor 115 to cause the system 100 to perform a particular function, such as display an indicia, emit a noise, flash a light, etc. In an embodiment, the security system may transmit an alarm signal when a buoy profile 140 indicates that a potentially dangerous environmental condition is within a certain range of the system 100. For instance, the security system may be configured to emit an alarm signal when a buoy profile 140 within five kilometers of the user 105 indicates that there is lightening in the area. In another embodiment, the security system may transmit an alarm signal when a plurality of buoy profile 140 indicate that a potentially dangerous environmental condition is approaching the system's 100 location. For instance, the security system may be configured to emit an alarm signal when a plurality of buoy profiles 140 indicates that a potentially dangerous environmental condition having winds in excess of thirty knots is approaching the user's 105 current location. In yet another embodiment, the security system may transmit an alarm signal when the at least one sensor 120 of the system 100 indicate that a potentially dangerous environmental condition is developing at the system's 100 location. For instance, the security system may be configured to transmit an alarm signal to the user 105 when the ambient light is approaching levels that may make it difficult for a user 105 to navigate.

In another embodiment, the security system may be a standard alarm system. The standard alarm system may be connected to the system 100 in a way such that a computer readable signal may be transmitted to a user 105 to alert the user 105 of a potential trespass to the user's 105 property. For instance, a standard alarm system configured to detect vibrations may alert a user 105 of a trespass to the user's 105 property when the standard alarm system detects footsteps while a user 105 is not present. For instance, a standard alarm signal configured to detect changes in light conditions may alert a user 105 of a potential trespass when sudden changes in ambient light conditions may be indicative of an unauthorized person using a flashlight about the user's 105 property. For instance, a standard alarm configured to detect changes in elevation may alert a user 105 when the barometric pressure suddenly changes, indicating the marine vehicle is being taken out of the water via a trailer. The alarm systems described herein may use information obtained from the at least one sensors 120 of the system 100 to determine whether or not to alert a user 105.

FIG. 5 provides a flow chart illustrating certain, preferred method steps that may be used to carry out the method for creating a buoy profile 140, mapping the buoy profile within a user interface 111, and presenting the buoy profiles 140 in the user interface 111 to a user 105 via a display. Step 505 indicates the beginning of the method. During step 510, the at least one sensor 120 of the system 100 may receive environmental data detailing the environmental conditions currently experienced by the marine vehicle and transfers the environmental data to the processor 115. In an embodiment, types of sensors that may be used as the at least one sensor 120 to collect environmental data may include, but are not limited to, GPS, barometer, accelerometer, gyroscope, camera, light sensor, electronics sensor, thermometer, humidity sensor, turbidity sensor, lightning sensor, microphone, engine monitor, radar, wind transducer, compass, depth transducer, and speed transducer, or any combination thereof. The processor 115 then determines a user's 105 geolocation in step 515. In an embodiment, geospatial data 142G is obtained using a GPS, but other methods may be used to determine a user's 105 geolocation without departing from the inventive subject matter as described herein. The system 100 may then create a buoy profile 140 from the environmental data and geospatial data 142G in step 520. In an embodiment, the system 100 may update the environmental data in real time as environmental data is received by the processor 115 from the at least one sensor 120. In another embodiment, the system 100 may average the environmental data received over a specified period of time to create a buoy profile 140. Alternatively, the system 100 may take the mean values of the environmental data points received from the at least one sensor 120 to create a buoy profile 140.

Once the system 100 has created the buoy profile 140, the system 100 may save the buoy profile 140 in a non-transitory computer-readable medium 116 during step 525. The processor 115 may then transfer the buoy profile 140 to the database 135 in step 530. In one embodiment, transfer to the database 135 may be accomplished via a server 130. Once the buoy profile 140 has been saved and transferred, the system 100 may query the database 135 to receive buoy profile data relevant to the user's 105 geolocation in step 535. In circumstance where a buoy profile already exists, the method may start at step 532 and immediately proceed to the query database step 535. The query may include any buoy profile 140 containing geospatial data 142G within a specific geographic range of the user 105. The processor determines how to proceed based on the results of the query in step 540. If the system 100 determines that there are no relevant buoy profiles 140, the system 100 may proceed to the terminate method step 560. If the system 100 determines that there are buoy profiles 140 relevant to the user's 105 geolocation, the processor 115 may receive the data contained within those buoy profiles 140 in step 545. The processor 115 may then map the buoy profiles 140 in a user interface 111 during step 550. In an embodiment, the buoy profiles 140 may be mapped within a GIS of the user interface 111. In another embodiment, the data within the buoy profiles 140 may also be represented within the user interface 111. Once the processor 115 has mapped the buoy profiles 140 within the user interface 111, the processor 115 may communicate with a display operably connected to the processor 115 in way such that the display may present the buoy profiles 140 within the user interface 111 to the user 105 in step 555. In an embodiment, a user 105 may operate a display presenting the buoy profiles 140 and buoy profile data in a way to cause the buoy profile data to not be visible to a user 105. Alternatively, a user 105 may operate the display in a way that causes the user interface 111 to present buoy profile data to the user 105. Once the processor 115 has presented the buoy profiles 140 within the user interface 111 via a display, the method may proceed to the terminate method step 560.

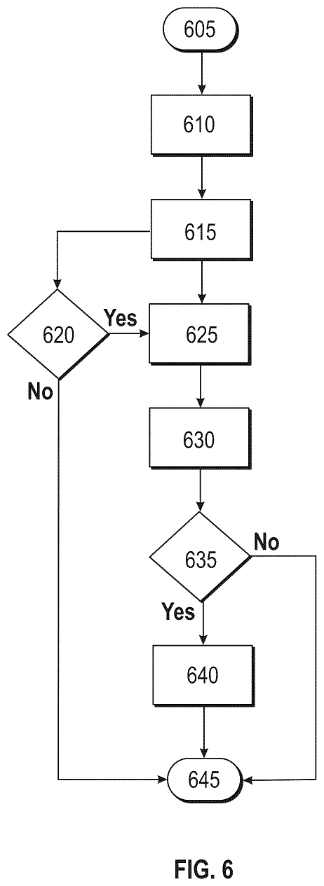

FIG. 6 provides a flow chart illustrating certain, preferred method steps that may be used to carry out the method for determining whether a potentially dangerous environmental condition is developing near the user's 105 geolocation and alerting a user 105 of the potentially dangerous developing environmental condition. Step 605 indicates the beginning of the method. During step 610, the processor 115 may determine the user's 105 geolocation. In an embodiment, a user's 105 geolocation may be determined by a GPS of the system 100. Using the user's 105 geolocation, the processor 115 may perform a query to find buoy profiles 140 having geospatial data 142G within a certain geographic range of the user's 105 geolocation in step 615. The processor 115 may then take the appropriate action based on the query in step 620. If the processor 100 determines that there are no relevant buoy profiles 140, the system 100 may proceed to the terminate method step 645. If the system 100 determines that there are buoy profiles 140 relevant to the user's 105 geolocation, the processor 115 may receive the data contained within those buoy profiles 140 during step 625.

In step 630, the processor 115 may analyze the environmental data of relevant buoy profiles to determine whether there is a potentially dangerous environmental condition present. The processor may take the appropriate action pending the results of the analysis in step 635. If the processor 115 determines that there are no potentially dangerous environmental conditions, the method may proceed to the terminate method step 645. If the processor 115 determines that there is a potentially dangerous environmental condition within a specified geolocation of the user 105, the processor 115 may alert the user 105 in step 640. In an embodiment, the system 100 may use an indicia within the user interface 111 to alert the user 105 of a developing dangerous environmental condition. For instance, a buoy profile 140 displayed within a user interface 111 via an indicia representing lightning may alert a user 105 of dangerous lighting conditions within the vicinity of the buoy profile 140. For instance, a buoy profile 140 displayed within a user interface 111 via an indicia representing wind may alert a user 105 of dangerously high wind conditions within the vicinity of the buoy profile 140. Once the system 100 has alerted the user 105 of a developing dangerous environmental condition, the method may proceed to the terminate method step 645.

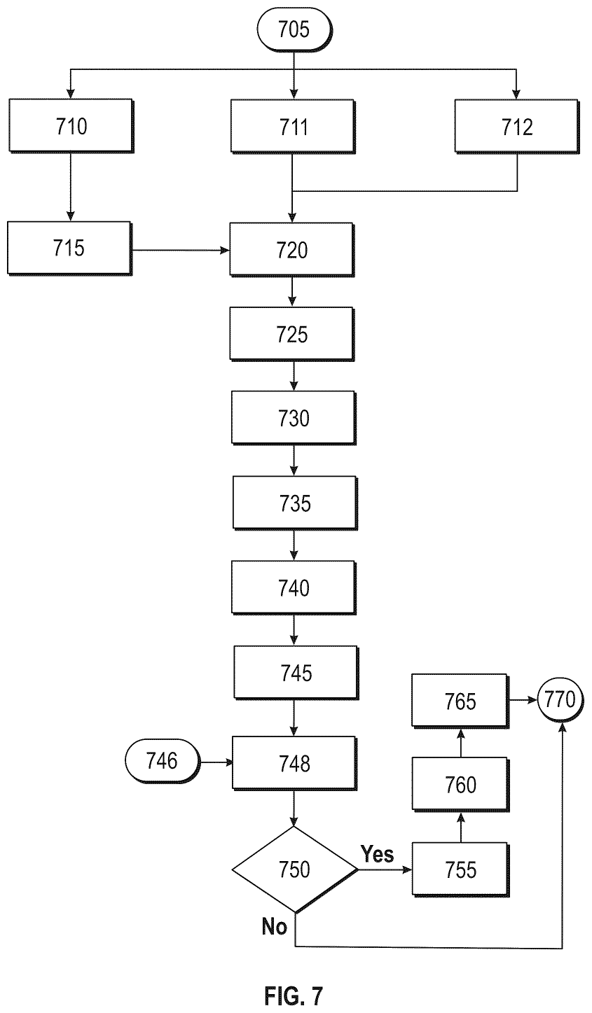

FIG. 7 provides a flow chart illustrating certain method steps that may be used to carry out the method for creating an activity profile 145, saving it within a database 135, and presenting activity profiles 145 to the user 105. Step 705 indicates the beginning of the method. During step 710, the processor 115 may receive environmental data from the at least one sensor 120 and then combine it to create an environmental state 142 in step 715. In an embodiment, the system 100 may create an environmental state 142 using environmental data recorded at the time the activity profile 145 was created. For instance, an activity profile 145 for fishing may include environmental data recorded at the time a species of marine life 210 was caught by the user 105. In another embodiment, the system 100 may average the environmental data received over a specified period of time to create the environmental state 142 of the activity profile 145. In yet another embodiment, the system 100 may take the mean values of the environmental data received from the at least one sensor 120 to create an environmental state 142 for an activity profile 145. Types of sensors that may be used as the at least one sensor 120 to collect environmental data may include, but are not limited to, GPS, barometer, accelerometer, gyroscope, camera, light sensor, electronics sensor, thermometer, humidity sensor, turbidity sensor, lightning sensor, microphone, engine monitor, radar, wind transducer, compass, depth transducer, and speed transducer, or any combination thereof.

The processor 115 may receive activity data 147 from the at least one sensor 120 during step 711. In an embodiment, the processor 115 may also receive marine equipment data from the equipment sensor 125 in step 712 and then combine it with the activity data 147 and environmental state in step 720 to create an activity profile 145. Activity data 147 may include various types information related to marine activities. For instance, activity data 147 may include, but is not limited to, the type of marine activity, equipment data, and catch data. Marine equipment data may include, but is not limited to, information relating to different types of marine equipment 127 that may be used for marine activities. Once the system 100 has created the activity profile 145, the system 100 may determine the geolocation of the user 105 at the time in which the activity profile 145 was created in step 725. In an embodiment, the system 100 may automatically acquire geospatial data 142G from an at least one sensor 120 comprising a GPS. Alternatively, the geospatial data 142G may be input by a user 105. For instance, a user 105 may input GPS coordinates using an input device when prompted for a geolocation. For instance, the user 105 may choose the geolocation using a map generated by the user interface 111, wherein locations on the map correspond to a particular geolocation. However, a user 105 may choose not to include geospatial data 142G within the activity profile 145 if desired. The processor 115 may then scan the network to obtain additional information that is relevant to the geolocation and time in which the activity profile was created in step 730. This information may include weather information, tide information, lunar data, and/or barometric pressure data 142F. The system 100 may then save the activity profile 145 in step 735.

Once the system 100 has saved the activity profile 145, the processor 115 may transfer the activity profile 145 to the database 135 in step 740. Once the processor 115 has saved the activity profile 145 and transferred it to the database 135, the processor 115 may perform a query to determine whether there are any activity profiles 145 within a certain geographic range of the user 105 and whether those activity profiles 145 match the current environmental state 142 in step 745. Alternatively, a user 105 may begin the method at step 742 and start a query in situations where no activity profile 145 needs to be created. The processor decides the appropriate course of action to take based on the query during step 750. Before this can be done, the processor 115 must create a current environmental state 142 in step 746 in the manners disclosed herein. If the processor 115 determines there are no relevant activity profiles 145, the system 100 may proceed to the terminate method step 770. If the processor 115 determines there are relevant activity profiles 145, the processor 115 may retrieve those activity profiles 145 from the database 135 in step 755.

Once the processor 115 has retrieved the relevant activity profiles 145, the processor 115 may map the relevant activity profiles 145 in a user interface 111 during step 760. In an embodiment, the activity profiles 145 are mapped within a GIS of the user interface 111. Once the processor 115 has mapped the activity profiles 145 within the user interface 111, the processor 115 may communicate with a display operably connected to the processor 115 in way such that the display may present the activity profiles 145 within the user interface 111 to the user 105 in step 765. In another embodiment, the activity data 147, environmental state 142, and equipment data of an activity profile 145 may also be presented to the user 105 via the display. In yet another embodiment, the computing device 110 may be configured in a way such that the user 105 may operate the computing device 110 hosting the user interface 111 in a way that causes the activity data 147, environmental state 142, and marine equipment data of an activity profile 145 to not be visible to the user 105 via the display. Alternatively, the computing device 110 may be configured in a way such that the user 105 may operate the computing device 110 hosting the user interface 111 in a way that causes the user interface 111 to present the activity data 147, environmental state 142, and marine equipment data of an activity profile 145 to the user 105 via the display. Once the processor 115 has presented the activity profiles 145 to the user 105 via the display, the method may proceed to the terminate method step 770.

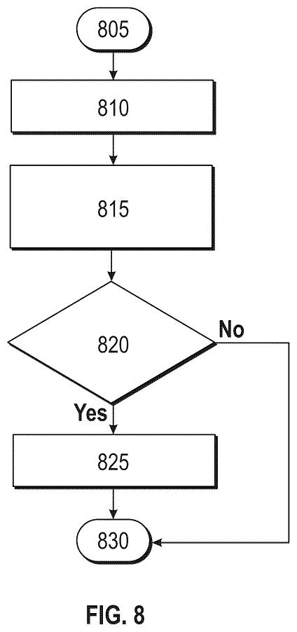

FIG. 8 provides a flow chart illustrating certain method steps that may be used to carry out the method for alerting a user 105 of an optimal fishing spot based on activity profiles 145 having a similar environmental state 142 to the current environmental state 142 of the marine vehicle as well as geospatial data 142G within a certain geographic range of the user's 105 geolocation. Step 805 indicates the beginning of the method. During step 810, the processor 115 may determine the current environmental state of the marine vehicle. In an embodiment, the processor 115 may create a current environmental state 142 based on the environmental data transmitted by the at least one sensor 120 to the processor 115. The environmental data may then be combined to transform the environmental data into a current environmental state 142. The processor 115 may then perform a query that compares the current environmental state 142 to environmental states 142 of activity profiles 145 within a certain geographic range of the user 105 in step 815. The processor determines the appropriate course of action based on the query during step 820. If the processor 115 determines that no activity profiles 145 match the current environmental state 142 of the marine vehicle, the method may proceed to the terminate method step 830. If the processor 115 determines that the current environmental state 142 matches an environmental state 142 of a relevant activity profile 145, the method may proceed to step 825. During step 825, the processor 115 may alert the user 105 of the optimal fishing location. In an embodiment, the system 100 may use an indicia within the user interface 111 to alert the user 105 of an optimal fishing location. For instance, an activity profile 145 displayed within a user interface 111 having a green highlight may alert a user 105 of optimal conditions for fishing. For instance, an activity profile 145 displayed within a user interface 111 having a red highlight may alert a user 105 that conditions are not optimal for fishing in a particular area. Once the system 100 has alerted the user 105, the method may proceed to the terminate method step 830.

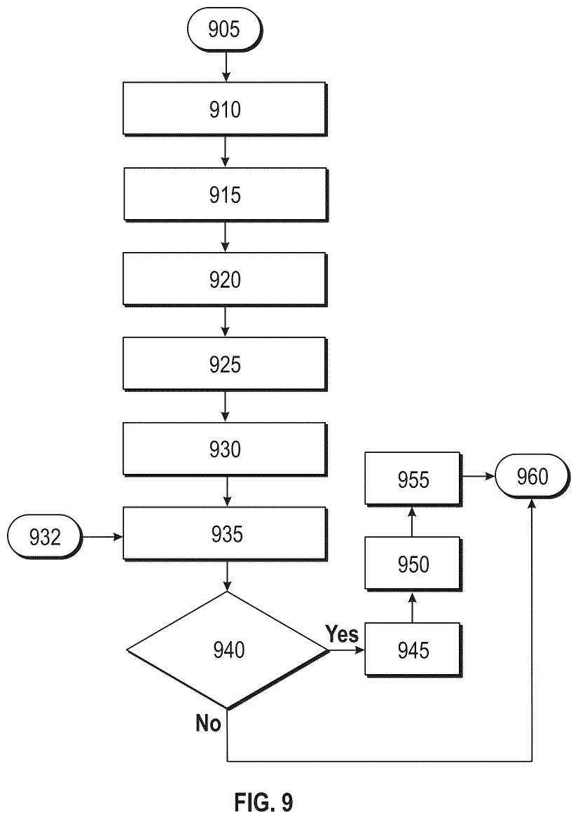

FIG. 9 provides a flow chart illustrating certain method steps that may be used to carry out the method for creating marker profiles 150, saving marker profiles 150 within a database 135, and presenting marker profiles 150 to the user 105. Step 905 indicates the beginning of the method. During step 910, a user 105 may input marker data into a user interface 111 using an input device operably connected to the computing device 110. Once the system 100 has received the marker data, the processor 115 may create a marker profile 150 in step 915. In an embodiment, marker profiles 150 represent a service or event related to marine activities. The system 100 may then determine the geolocation of the user 105 at the time in which the marker profile 150 was created in step 920. Alternatively, the geospatial data 142G may be input by a user 105. For instance, a user 105 may input GPS coordinates using an input device when prompted for a geolocation. For instance, the user 105 may choose the geolocation using a map generated by the user interface 111, wherein locations on the map correspond to a particular geolocation. However, a user 105 may choose not to include geospatial data 142G within the marker profile 150 if desired. Once the system 100 has added the geospatial data 142G to the marker profile 150, the processor 115 may save the marker profile 150 to the non-transitory computer-readable medium 116 during step 925. The processor 115 may then transfer the marker profile 150 to the database 135 in step 930.

Once the processor 115 has saved the marker profile 150 and transferred it to the database 135, the processor 115 may perform a query to determine whether there are any marker profiles 150 within a certain geographic range of the user 105 during step 935. Alternatively, a user 105 may begin the method at step 932 if no marker profile 150 needs to be created. The processor determines the appropriate course of action based on the query in step 940. If the processor 115 determines there are no relevant marker profiles 150, the system 100 may proceed to the terminate method step 960. If the processor 115 determines there are relevant marker profiles 150, the processor 115 may retrieve those marker profiles 150 from the database 135 in step 945. Once the processor 115 has retrieved the relevant marker profiles 150, the processor 115 may map the relevant marker profiles 150 in a user interface 111 during step 950. In an embodiment, the marker profiles 150 are mapped within a GIS of the user interface 111. Once the processor 115 has mapped the marker profiles 150 within the user interface 111, the processor 115 may communicate with a display operably connected to the processor 115 in way such that the display may present the marker profiles 150 within the user interface 111 to the user 105 in step 955. In another embodiment, the marker data of a marker profile 150 may also be presented to the user 105 via the display. In yet another embodiment, the computing device 110 may be configured in a way such that the user 105 may operate the computing device 110 hosting the user interface 111 in a way that causes the marker data of a marker profile 150 to not be visible to the user 105 via the display. Alternatively, the computing device 110 may be configured in a way such that the user 105 may operate the computing device 110 hosting the user interface 111 in a way that causes the user interface 111 to present the marker data of a marker profile 150 to the user 105 via the display. Once the processor 115 has presented the marker profiles 150 to the user 105 via the display, the method may proceed to the terminate method step 960.

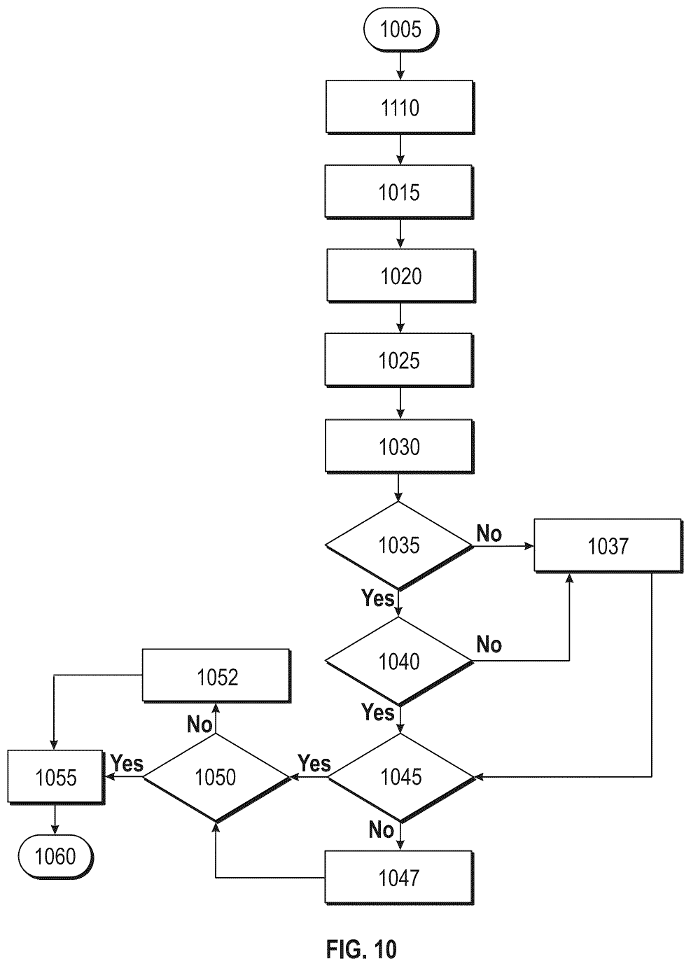

FIG. 10 provides a flow chart illustrating certain method steps that may be used to carry out the method for creating an activity profile 145 from a digital image 205 of marine life 210. Step 1005 indicates the beginning of the method. During step 1010, the processor 115 may receive a digital image 205 of marine life 210 from the computing device 110. After receiving the digital image, the processor 115 may save the digital image 205 within the non-transitory computer-readable medium 116 in step 1015. The processor 115 may then create an activity profile 145 based on the digital image 205 during step 1020. Once the processor 115 has created the activity profile 145, the processor 115 may extract meta data from the digital image 205 in step 1025. In an embodiment, the meta data may comprise of environmental data and activity data 147. The environmental data and activity data 147 may represent the environmental conditions and equipment used during a marine activity. In one embodiment, the processor 115 may receive environmental data from that at least one sensor 120 once a digital image 205 has been received and an activity profile 145 has been created based on that digital image.

Once the system 100 has extracted the meta data, the processor 115 may transfer the meta data to the activity profile 145 in step 1030. The user may then have the processor 115 determine if a species of marine life 210 is present within the digital image 205 in step 1035. If the user 105 allows the processor 115 to determine the species of marine life 210 present within the digital image, the processor 115 may determine the species of marine life 210 within the digital image. In an embodiment, the system 100 may use a machine learning technique to determine the species of marine life 210 within the digital image. Alternatively, the user 105 may optionally skip the step of capturing a digital image 205 of the marine life 210 and simply select the species from the list as previously described in step 1037. If the system cannot determine the species of marine life in step 1040, the method may proceed to step 1037. If the system does determine the species of marine life in step 1040, the method may proceed to step 1045. Once the species of marine life 210 within the digital image 205 has been established, the system 100 may determine the length 220 of the marine life 210 and transmit the length data to the activity profile 145 in step 1045. In one embodiment, the system 100 may use a machine learning technique to determine the length 220 of the marine life 210 within the digital image. Alternatively, the user 105 may optionally skip the step of having the system determine the length of the marine life 210 and manually input the length in step 1047.

Once the system 100 has determined the length 220 of the marine life 210 within the digital image 205, the system 100 may transmit the length data to the activity profile 145. In yet another embodiment, the system 100 may determine the weight 215 of a species of marine life 210 within a digital image 205 as shown in step 1050. In an embodiment, the system 100 may use a scale 129 to determine the weight 215 of the marine life 210 within the digital image 205 in a way such that the scale 129 may transmit the weight data to the processor 115. Alternatively, the user 105 may optionally skip the step of having the system 100 determine the weight 215 of the marine life 210 and manually input the weight 215 in step 1052. Once the the weight 215 of the marine life 210 has been determined, the system 100 may transmit the weight data to the activity profile 145. The system 100 may then proceed to the save activity profile step 1055. In step 1055, the processor 115 may save the activity profile 145 to the non-transitory computer-readable medium 116. Once the activity profile 145 has been saved, the method may proceed to the terminate method step 1060.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one input/output device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For example, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter

What is claimed is:

1. A system for determining activity on a marine vehicle comprising:
a first sensor operably connected to a NMEA device,
wherein said first sensor collects environmental data concerning an environment about said marine vehicle;
a processor operably connected to said first sensor via said NMEA device,
wherein said processor is configured to receive said environmental data transmitted by said first sensor;
a server operably connected to said processor via a network,
wherein said processor is configured to transmit said environmental data to said server; and
a computing device having a user interface and operably connected to said server,
wherein said user interface is configured to allow a user to check a status of said marine vehicle by accessing said environmental data,
wherein said computing device alerts said user via said user interface when a current environmental state deviates from a normal environmental state,
wherein said current environmental state represents said environment that said marine vehicle is experiencing in approximately real-time,
wherein said normal environmental state represents said environment normally experienced by said marine vehicle in a particular environment.

2. The system of claim 1, further comprising a non-transitory computer-readable medium coupled to said processor and having instructions stored thereon, which, when executed by said processor, cause said processor to perform operations comprising:
receiving said environmental data transmitted by said first sensor;
creating a current environmental state using said environmental data;
determining when said current environmental state deviates from a normal environmental state of said marine vehicle; and
sending a computer readable signal to said computing device when it is determined said current environmental state has deviated from said normal environmental state.

3. The system of claim 1, further comprising:
a second sensor operably connected to said processor via a wireless communication device,
wherein said second sensor collects said environmental data concerning said environment about said marine vehicle,
wherein said processor is configured to receive said environmental data transmitted by said second sensor.

4. The system of claim 1, further comprising an input/output device of said computing device,
wherein said processor sends a computer readable signal to said input/output device that causes said input/output device to perform an action when said environment deviates from said normal environmental state.

5. The system of claim 1, further comprising an alarm system operably connected to said processor and said first sensor,
wherein said processor is configured to send a computer readable signal to said computing device when said alarm system determines said current environmental state deviates from said normal environmental state.

6. The system of claim 5, wherein said alarm system is configured to not send said computer readable signal when said user is on said marine vehicle.

7. The system of claim 5, wherein said first sensor operably connected to said alarm system comprises a barometric pressure sensor configured to collect barometric pressure data as said environmental data, wherein said processor is configured to send a computer readable signal to said computing device when said alarm system determines that said barometric pressure data indicates that said marine vehicle is being moved.

8. The system of claim 5, wherein said first sensor operably connected to said alarm system is configured to detect vibration data that indicate footsteps, wherein said processor is configured to send a computer readable signal to said computing device when said alarm system determines that said vibration data indicates said footsteps.

9. The system of claim 5, wherein said first sensor operably connected to said alarm system is configured to detect light data, wherein said processor is configured to send a computer readable signal to said computing device when said alarm system determines that said light data indicates a change in light conditions.

10. A system for determining activity on a marine vehicle comprising:
a sensor configured to collect environmental data concerning an environment about a marine vehicle;
a processor operably connected to said sensor and a NMEA device,
wherein said processor is configured to receive said environmental data transmitted by said sensor,
wherein said processor is configured to receive information concerning said marine vehicle via said NMEA device;
an input/output device operably connected to said processor,
wherein said processor sends a computer readable signal to said input/output device that causes said input/output device to perform an action when a current environment state deviates from a normal environmental state;
a server operably connected to said processor via a network,
wherein said processor is configured to transmit said environmental data to said server; and
a computing device having a user interface and operably connected to said server,
wherein said user interface is configured to allow a user to check a status of said marine vehicle by accessing said environmental data,
wherein said computing device alerts said user via said user interface when a current environmental state deviates from a normal environmental state,
wherein said current environmental state represents said environment that said marine vehicle is experiencing in approximately real-time,
wherein said normal environmental state represents said environment normally experienced by said marine vehicle in a particular environment.

11. The system of claim 10, further comprising a non-transitory computer-readable medium coupled to said processor and having instructions stored thereon, which, when executed by said processor, cause said processor to perform operations comprising:
receiving said environmental data transmitted by said sensor;
creating a current environmental state using said environmental data; and
determining when said current environmental state deviates from a normal environmental state of said marine vehicle.

12. The system of claim 11, further comprising additional instructions stored on said non-transitory computer-readable medium, which, when executed by said processor, cause said processor to perform additional operations comprising:
determining if said user is on said marine vehicle; and
sending a computer readable signal to said input/output device when it is determined said normal environmental state has deviated from said normal environmental state and said user is not on said marine vehicle.

13. The system of claim 11, further comprising additional instructions stored on said non-transitory computer-readable medium, which, when executed by said processor, cause said processor to perform additional operations comprising:
determining when said current environmental state indicates a change in elevation consistent with being removed from a water source based on barometric pressure data,
wherein said barometric pressure data is collected by a barometric pressure sensor acting as said sensor.

14. The system of claim 11, further comprising additional instructions stored on said non-transitory computer-readable medium, which, when executed by said processor, cause said processor to perform additional operations comprising:
determining when said current environmental state indicates a change in vibration conditions consistent with human activity based on vibration data,
wherein said vibration data is collected by a vibration sensor acting as said sensor.

15. The system of claim 11, further comprising additional instructions stored on said non-transitory computer-readable medium, which, when executed by said processor, cause said processor to perform additional operations comprising:
determining when said current environmental state indicates a change in light conditions via an artificial light source based on light data,
wherein said light data is collected by a light sensor acting as said sensor.

16. A method for determining activity on a marine vehicle comprising steps of:
receiving, by a processor, environmental data transmitted by at least one sensor,
wherein said at least one sensor is operably connected to said processor via a NMEA device,
wherein said NMEA device is secured to a marine vehicle;
creating a current environmental state using said environmental data;
determining when said current environmental state of said marine vehicle deviates from a normal environmental state of said marine vehicle; and
sending a computer readable signal to a computing device when it is determined said current environmental state indicates a deviation from said normal environmental state.

17. The method of claim 16, further comprising additional steps of:
determining if a user is on said marine vehicle; and
sending a computer readable signal to an input/output device when it is determined said current environmental state indicates a deviation from said normal environmental state and said user is not on said marine vehicle.

18. The method of claim 16, further comprising additional steps of:
determining when said current environmental state indicates a change in elevation consistent with being removed from a water source based on barometric pressure data,
wherein said barometric pressure data is collected by a barometric pressure sensor acting as said at least one sensor.

19. The method of claim 16, further comprising additional steps of:
determining when said current environmental state indicates a change in vibration conditions consistent with human activity based on vibration data,
wherein said vibration data is collected by a vibration sensor acting as said at least one sensor.

20. The method of claim 16, further comprising additional steps of:
determining when said current environmental state indicates a change in light conditions via an artificial light source based on light data,
wherein said light data is collected by a light sensor acting as said at least one sensor.
